(19) United States
(12) Patent Application Publication
(10) Pub. No.: US 2013/0077039 A1
(43) Pub. Date: Mar. 28, 2013

(54) APPARATUS AND METHOD FOR PRODUCING PRE-TILT ANGLE IN LIQUID CRYSTAL PANEL, SAMPLE STAGE AND LIGHT SOURCE APPARATUS

(71) Applicants: Kuan-cheng Lee, Shenzhen (CN); Chunliang Lee, Shenzhen (CN)

(72) Inventors: Kuan-cheng Lee, Shenzhen (CN); Chunliang Lee, Shenzhen (CN)

(73) Assignee: Shenzhen China Star Optoelectronics Technology Co., LTD., Shenzhen, Guangdong (CN)

(21) Appl. No.: 13/375,228

(22) PCT Filed: Sep. 23, 2011
(86) PCT No.: PCT/CN11/80070

§ 371 Date: Nov. 30, 2011

(51) Int. Cl. G02F 1/1337; F21V 9/00; H01J 9/20

(52) U.S. Cl. 349/191; 445/60; 362/293

(57) ABSTRACT

An apparatus and a method for producing a pre-tilt angle in a liquid crystal panel are disclosed. The apparatus includes a sample stage for placing the liquid crystal panel, at least one ultraviolet (UV) light source for irradiating the liquid crystal panel so that a filler material in a liquid crystal layer rotated to a preset angle can be cured to form a pre-tilt angle, and A UV filtering sheet transmissive to UV rays with wavelengths of 320 nm to 380 nm disposed between the sample stage and the UV light source. By disposing the UV filtering sheet, the filler material in the liquid crystal layer can be quickly cured and a desirable pre-tilt angle can be formed. This shortens the time of UV irradiation, improves the efficiency of producing a pre-tilt angle in the liquid crystal panel and lowers the manufacturing cost of the liquid crystal panel.

### BACKGROUND

1. Technical Field

The present invention relates to the technical field of liquid crystal panels, and more particularly, to an apparatus and a method for producing a pre-tilt angle in a liquid crystal panel, a sample stage and a light source apparatus.

2. Description of Related Art

Manufacturing of a liquid crystal panel is a very complex procedure that includes more than 300 steps, all of which must be carried out in dust-free environments.

The whole procedure of manufacturing a liquid crystal panel may be divided into the following major processes: (1) an array pattern process; (2) an alignment process; (3) a cell process; (4) a liquid crystal panel cutting & filling (liquid crystal) process; and (5) a quality inspection process.

Specifically, the alignment process comprises the following steps: an alignment film is coated on a glass substrate as specified, and the surface of the alignment film is rubbed by a piece of charpie to form aligned grooves on the surface of the alignment film. Then, the alignment film formed with the aligned grooves is cured to obtain a pre-tilt angle, thus completing the alignment process.

Additionally, in the prior art, the alignment process may also be carried out following the liquid crystal cutting & filling (liquid crystal) process, in which case the detailed process flow of the alignment process will be different from what described above. Furthermore, a filler material has to be incorporated in the liquid crystal material that is filled during the liquid crystal cutting & filling (liquid crystal) process. The detailed process is as follows: upon completion of the liquid crystal cutting & filling process, the liquid crystal panel is charged to rotate the liquid crystal molecules to a preset angle, and then the liquid crystal panel is irradiated by UV rays to cure the filler material in the liquid crystal, thus obtaining a pre-tilt angle.

In the latter alignment process, because of the wide band of wavelengths of the UV rays used, the irradiation has an undesirable effect on the filler material, and the relatively long time required to irradiate the filler material reduces the speed and efficiency of manufacturing the liquid crystal panel.

### BRIEF SUMMARY OF THE INVENTION

A primary objective of the present invention is to provide an apparatus and a method for producing a pre-tilt angle in a liquid crystal panel, as well as a sample stage and a light source apparatus which can improve the efficiency of manufacturing liquid crystal panels.

The present invention provides an apparatus for producing a pre-tilt angle in a liquid crystal panel, which comprises a sample stage and at least one ultraviolet (UV) light source. The sample stage is used for placing the liquid crystal panel thereon. The UV light source is adapted to irradiate the liquid crystal panel so that a filler material in a liquid crystal layer that has been rotated to a preset angle is cured to form a pre-tilt angle. A UV filtering sheet is disposed between the sample stage and the UV light source and is only transmissive to UV rays with wavelengths of 320 nm to 380 nm.

Preferably, an area irradiated by the UV light source is smaller than an area of an upper surface of the UV filtering sheet.

Preferably, the area irradiated by the UV light source is equal to the area of the upper surface of the UV filtering sheet.

Preferably, the UV light source has an output power of 85 nW.

The present invention further provides a sample stage, which comprises a sample stage body for placing a liquid crystal panel thereon. A UV filtering cover is disposed on the sample stage body and is only transmissive to UV rays with wavelengths of 320 nm to 380 nm, and a space formed by the sample stage body and the UV filtering cover is adapted to accommodate the liquid crystal panel therein.

Preferably, an inner surface of a top wall of the UV filtering cover has the profile as a surface of the liquid crystal panel.

Preferably, an area of the inner surface of the top wall of the UV filtering cover is greater than an area of the surface of the liquid crystal panel.

Preferably, the area of the inner surface of the top wall of the UV filtering cover is equal to the area of the surface of the liquid crystal panel.

The present invention further provides a light source apparatus, which comprises a UV luminescent lamp body and a protective cover disposed around the UV luminescent lamp body. A UV filtering cover is connected with the protective cover and is only transmissive to UV rays with wavelengths of 320 nm to 380 nm. The UV luminescent lamp body is disposed in a space formed by the protective cover and the UV filtering cover so that all UV rays received by an irradiated object are filtered by the UV filtering cover.

Preferably, the protective cover is seamlessly connected with the UV filtering cover so that the UV luminescent lamp body is disposed in a closed space formed by the protective cover and the UV filtering cover.

Preferably, the UV luminescent lamp body has an output power of 85 nW.

The present invention further provides a method for producing a pre-tilt angle in a liquid crystal panel, comprising the following steps of:
disposing a UV filtering sheet between a sample stage and a UV light source;
placing the liquid crystal panel on the sample stage, wherein the liquid crystal panel is charged so that liquid crystal molecules in a liquid crystal layer between a thin film transistor (TFT) substrate and a color filter (CF) substrate are rotated to a preset angle; and
irradiating the liquid crystal panel by use of UV rays, which have wavelengths of 320 nm to 380 nm and are transmitted through the UV filtering sheet, to cure a filler material in the liquid crystal layer so as to form the pre-tilt angle.

Preferably, an area irradiated by the UV light source is smaller than an area of an upper surface of the UV filtering sheet.

Preferably, the area irradiated by the UV light source is equal to the area of the upper surface of the UV filtering sheet.

Preferably, the UV light source has an output power of 85 nW.

Preferably, the liquid crystal panel is placed on the sample stage in such a way that the thin film transistor substrate of the liquid crystal panel faces upwards.

Preferably, the liquid crystal panel is placed on the sample stage in such a way that the color filter substrate of the liquid crystal panel faces upwards.

According to the apparatus and the method for producing a pre-tilt angle in a liquid crystal panel, the sample stage and the light source apparatus of the present invention, a desirable pre-tilt angle is formed by disposing a UV filtering sheet between the sample stage and the UV light source for allowing UV rays with wavelengths of 320 nm to 380 nm to transmit therethrough to quickly cure the filler material in the liquid crystal layer. This shortens the time of UV irradiation, improves the efficiency of producing a pre-tilt angle in the liquid crystal panel and lowers the manufacturing cost of the liquid crystal panel.

### BRIEF DESCRIPTION OF THE DRAWINGS

FIG. 1 is a schematic structural view of an embodiment of an apparatus for producing a pre-tilt angle in a liquid crystal panel according to the present invention;

FIG. 2 is a schematic structural view of an embodiment of a sample stage according to the present invention;

FIG. 3 is a schematic structural view of an embodiment of a light source apparatus according to the present invention; and

FIG. 4 is a flowchart diagram of an embodiment of a method for producing a pre-tilt angle in a liquid crystal panel according to the present invention.

Hereinafter, implementations, functional features and advantages of the present invention will be further described with reference to embodiments thereof and the attached drawings.

### DETAILED DESCRIPTION

It shall be understood that, the embodiments described herein are only intended to illustrate but not to limit the present invention. It shall also be firstly noted that, for convenience of description, the attached drawings are presented in a schematic manner with components unrelated to the present invention being omitted from depiction therein.

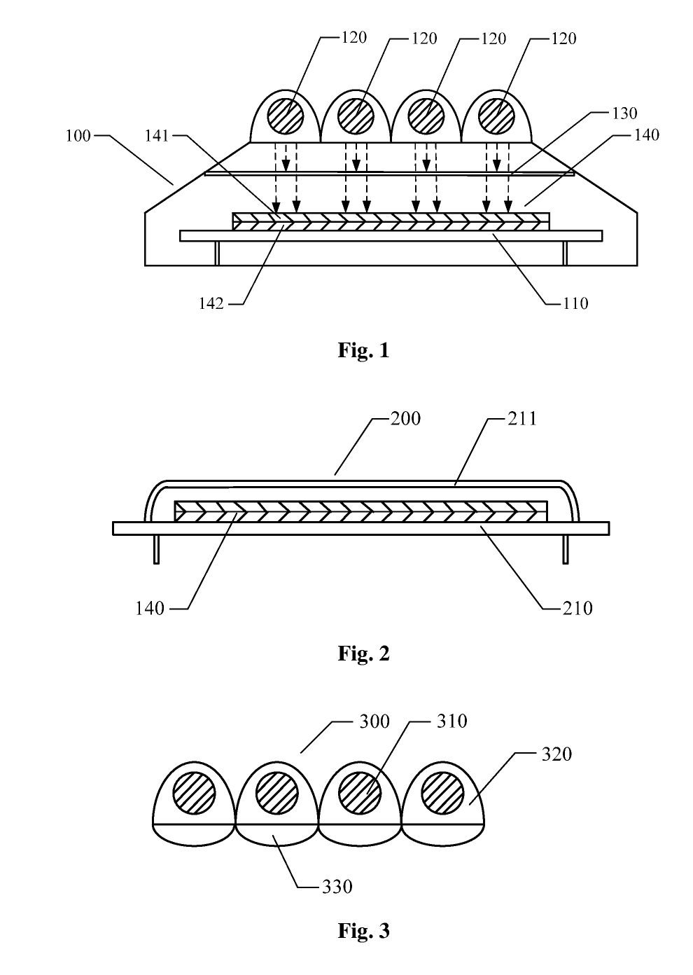

Referring to FIG. 1, there is shown an embodiment of an apparatus 100 for producing a pre-tilt angle in a liquid crystal panel according to the present invention. The apparatus 100 for producing a pre-tilt angle in a liquid crystal panel comprises a sample stage 110 and at least one UV light source 120. The sample stage 110 is used for placing the liquid crystal panel 140 thereon. The UV light source 120 is adapted to irradiate the liquid crystal panel 140 so that a filler material that has been rotated to a preset angle in the liquid crystal layer is cured to form a pre-tilt angle. A UV filtering sheet 130 is disposed between the sample stage 110 and the UV light source 120, and is only transmissive to UV rays with wavelengths of 320 nm to 380 nm.

Further, in this embodiment of the apparatus 100 for producing a pre-tilt angle in a liquid crystal panel, an area irradiated by the UV light source 120 is smaller than or equal to an area of an upper surface of the UV filtering sheet 130 in order to ensure that all UV rays received by the liquid crystal panel are filtered by the UV filtering sheet 130.

Further, in this embodiment of the apparatus 100 for producing a pre-tilt angle in a liquid crystal panel, the UV light source 120 has an output power of 85 nW.

The liquid crystal panel 140 comprises a thin film transistor (TFT) substrate 141 and a color filter (CF) substrate 142. Between the TFT substrate 141 and the

CF substrate 142 is disposed a liquid crystal layer (not shown), which is formed by a uniform mixture of a liquid crystal material and a filler material. The filler material is adapted to be cured when being irradiated by UV rays. When the liquid crystal panel 140 is energized at a preset voltage, the liquid crystal molecules will drive the filler material to rotate to a preset angle. Then, the filler material is cured through irradiation of the UV rays to form a fixed pre-tilt angle. The curing time for the filler material to cure and the curing effect vary with different wavelengths of the UV rays. When UV rays with wavelengths of 320 nm to 380 nm are used for irradiation, the curing time will be the shortest and the optimal curing effect be obtained.

Further, the TFT substrate 141 of the liquid crystal panel 140 faces upwards when the liquid crystal panel 140 is placed on the sample stage 110 to produce the pre-tilt angle. In other alternative embodiments, it is also possible that the CF substrate 142 faces upwards when the liquid crystal panel 140 is placed on the sample stage 110 to produce the pre-tilt angle.

In this embodiment of the apparatus 100 for producing a pre-tilt angle in a liquid crystal panel, a UV filtering sheet 130 is disposed between the sample stage 110 and the UV light source 120 to allow UV rays with wavelengths of 320 nm to 380 nm to transmit therethrough to irradiate the liquid crystal panel 140. In this way, the time required to produce a pre-tilt angle in the liquid crystal panel 140 is shortened, and the curing effect of producing the pre-tilt angle in the liquid crystal panel 140 is improved.

Referring to FIG. 2, there is shown an embodiment of a sample stage 200 according to the present invention. The sample stage 200 comprises a sample stage body 210 for placing the liquid crystal panel 140 thereon. On the sample stage body 210 is disposed a UV filtering cover 211 that is only transmissive to UV rays with wavelengths of 320 nm to 380 nm. A space formed by the sample stage body 210 and the UV filtering cover 211 is adapted to accommodate the liquid crystal panel 140 therein.

Further, in this embodiment of the sample stage 200, an inner surface of a top wall of the UV filtering cover 211 has the same profile as a surface of the liquid crystal panel 140.

Further, in this embodiment of the sample stage 200, an area of the inner surface of the top wall of the UV filtering cover 211 is greater than an area of the surface of the liquid crystal panel 140.

Further, in this embodiment of the sample stage 200, the area of the inner surface of the top wall of the UV filtering cover 211 may be equal to the area of the surface of the liquid crystal panel 140.

When the sample stage 200 of this embodiment is used to produce a pre-tilt angle in the liquid crystal panel (i.e., during the process of producing a pre-tilt angle in the liquid crystal panel), the liquid crystal panel 140 that has been energized is placed in the space formed by the sample stage body 210 of the sample stage 200 and the UV filtering cover 211, and is then irradiated by a common UV light source. Because the liquid crystal panel 140 is placed in the space formed by the sample stage body 210 and the UV filtering cover 211, all UV rays received by the liquid crystal panel 140 have been filtered by the UV filtering cover 211; i.e., the UV rays received have wavelengths ranging between 320 nm and 380 nm. In this way, the filler material that has been rotated to a preset angle along with the liquid crystal molecules can be cured rapidly, thus shortening the time required to produce the pre-tilt angle in the liquid crystal panel and improving the curing effect of producing the pre-tilt angle in the liquid crystal panel.

Referring to FIG. 3, there is shown an embodiment of a light source apparatus 300 according to the present invention. The UV light source apparatus 300 comprises a UV luminescent lamp body 310, a protective cover 320 disposed around the UV luminescent lamp body 310, and a UV filtering cover 330 connected with the protective cover 320. The UV filtering cover 330 is only transmissive to UV rays with wavelengths of 320 nm to 380 nm. The UV luminescent lamp body 310 is disposed in a space formed by the protective cover 320 and the UV filtering cover 330 so that all UV rays received by the irradiated object have been filtered by the UV filtering cover 330.

Further, in this embodiment of the light source apparatus 300, the protective cover 320 is seamlessly connected with the UV filtering cover 330 so that the UV luminescent lamp body 310 is disposed in a closed space formed by the protective cover 320 and the UV filtering cover 330.

Further, in this embodiment of the light source apparatus 300, the UV luminescent lamp body 310 has an output power of 85 nW.

When the light source apparatus 300 of this embodiment is used to produce a pre-tilt angle in the liquid crystal panel (i.e., during the process of producing a pre-tilt angle in the liquid crystal panel), the liquid crystal panel 140 that has been energized is placed under the light source apparatus 300 of this embodiment for irradiation. Because the light source apparatus 300 is provided with the UV filtering cover 330, all UV rays received by the liquid crystal panel 140 have been filtered by the UV filtering cover 330; i.e., the UV rays received have wavelengths ranging between 320 nm and 380 nm. In this way, the filler material that has been rotated to a preset angle along with the liquid crystal molecules can be cured rapidly, thus shortening the time required to produce the pre-tilt angle in the liquid crystal panel and improving the curing effect of producing the pre-tilt angle in the liquid crystal panel.

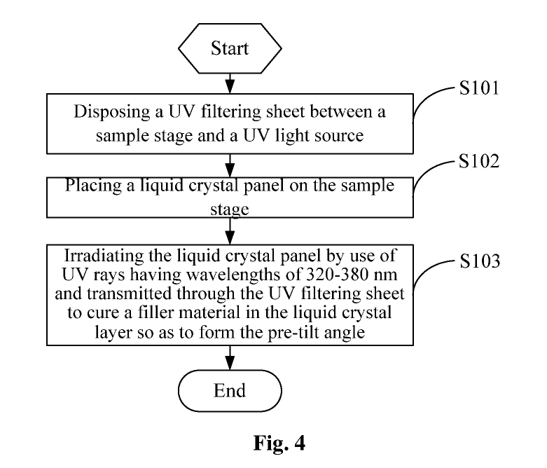

Referring to FIG. 4, there is shown an embodiment of a method for producing a pre-tilt angle in a liquid crystal panel according to the present invention. This method is based on the apparatus for producing a pre-tilt angle in a liquid crystal panel of the embodiment shown in FIG. 1. This method comprises the following steps.

Step S101: disposing a UV filtering sheet between a sample stage and a UV light source.

Step S102: placing a liquid crystal panel on the sample stage.

The liquid crystal panel is charged so that liquid crystal molecules in a liquid crystal layer between a TFT substrate and a CF substrate are rotated to a preset angle.

Step S103: irradiating the liquid crystal panel by use of UV rays, which have wavelengths of 320 nm to 380 nm and are transmitted through the UV filtering sheet, to cure a filler material in the liquid crystal layer so as to form the pre-tilt angle.

In this embodiment of the method for producing a pre-tilt angle in a liquid crystal panel, the time for the filler material to cure and the curing effect vary with different wavelengths of the UV rays. When UV rays with wavelengths of 320 nm to 380 nm are used for irradiation, the curing time will be the shortest and the optimal curing effect be obtained.

Further, in this embodiment of the method for producing a pre-tilt angle in a liquid crystal panel, an area irradiated by the UV light source is smaller than or equal to an area of an upper surface of the UV filtering sheet in order to ensure that all UV rays received by the liquid crystal panel are filtered by the UV filtering sheet.

Further, in this embodiment of the method for producing a pre-tilt angle in a liquid crystal panel, the UV light source has an output power of 85 nW.

Further, in this embodiment of the method for producing a pre-tilt angle in a liquid crystal panel, the liquid crystal panel is placed on the sample stage in such a way that the TFT substrate of the liquid crystal panel faces upwards. In other alternative embodiments, it is also possible that the CF substrate 142 faces upwards when the liquid crystal panel 140 is placed on the sample stage 110 to produce the pre-tilt angle.

In this embodiment of the method for producing a pre-tilt angle in a liquid crystal panel, a UV filtering sheet is disposed between the sample stage and the UV light source to allow UV rays with wavelengths of 320 nm to 380 nm to transmit therethrough to irradiate the liquid crystal panel. In this way, the time required to produce a pre-tilt angle in the liquid crystal panel is shortened, and the curing effect of producing the pre-tilt angle of the liquid crystal panel is improved.

What described above are only preferred embodiments of the present invention but are not intended to limit the scope of the present invention. Accordingly, any equivalent structural or process flow modifications that are made on basis of the specification and the attached drawings or any direct or indirect applications in other technical fields shall also fall within the scope of the present invention.

1. An apparatus for producing a pre-tilt angle in a liquid crystal panel, comprising a sample stage and at least one ultraviolet (UV) light source, the sample stage being adapted to place the liquid crystal panel thereon, the UV light source is adapted to irradiate the liquid crystal panel so that a filler material in a liquid crystal layer that has been rotated to a preset angle is cured to form a pre-tilt angle, wherein a UV filtering sheet is disposed between the sample stage and the UV light source and is only transmissive to UV rays with wavelengths of 320 nm to 380 nm.

2. The apparatus for producing a pre-tilt angle in a liquid crystal panel of claim 1, wherein an area irradiated by the UV light source is smaller than an area of an upper surface of the UV filtering sheet.

3. The apparatus for producing a pre-tilt angle in a liquid crystal panel of claim 1, wherein the area irradiated by the UV light source is equal to the area of the upper surface of the UV filtering sheet.

4. The apparatus for producing a pre-tilt angle in a liquid crystal panel of claim 1, wherein the UV light source has an output power of 85 nW.

5. A sample stage, comprising a sample stage body for placing a liquid crystal panel thereon, wherein a UV filtering cover is disposed on the sample stage body and is only transmissive to UV rays with wavelengths of 320 nm to 380 nm, and a space formed by the sample stage body and the UV filtering cover is adapted to accommodate the liquid crystal panel therein.

6. The sample stage of claim 5, wherein an inner surface of a top wall of the UV filtering cover has the profile as a surface of the liquid crystal panel.

7. The sample stage of claim 6, wherein an area of the inner surface of the top wall of the UV filtering cover is greater than an area of the surface of the liquid crystal panel.

8. The sample stage of claim 6, wherein the area of the inner surface of the top wall of the UV filtering cover is equal to the area of the surface of the liquid crystal panel.

9. A light source apparatus, comprising a UV luminescent lamp body and a protective cover disposed around the UV luminescent lamp body, wherein a UV filtering cover is connected with the protective cover and is only transmissive to UV rays with wavelengths of 320 nm to 380 nm, and the UV luminescent lamp body is disposed in a space formed by the protective cover and the UV filtering cover so that all UV rays received by an irradiated object are filtered by the UV filtering cover.

10. The light source apparatus of claim 9, wherein the protective cover is seamlessly connected with the UV filtering cover so that the UV luminescent lamp body is disposed in a closed space formed by the protective cover and the UV filtering cover.

11. The light source apparatus of claim 10, wherein the UV luminescent lamp body has an output power of 85 nW.

12. A method for producing a pre-tilt angle in a liquid crystal panel, comprising the following steps of:
disposing a UV filtering sheet between a sample stage and a UV light source;
placing the liquid crystal panel on the sample stage, wherein the liquid crystal panel is charged so that liquid crystal molecules in a liquid crystal layer between a thin film transistor (TFT) substrate and a color filter (CF) substrate are rotated to a preset angle; and
irradiating the liquid crystal panel by use of UV rays, which have wavelengths of 320 nm to 380 nm and are transmitted through the UV filtering sheet, to cure a filler material in the liquid crystal layer so as to form the pre-tilt angle.

13. The method for producing a pre-tilt angle in a liquid crystal panel of claim 12, wherein an area irradiated by the UV light source is smaller than an area of an upper surface of the UV filtering sheet.

14. The method for producing a pre-tilt angle in a liquid crystal panel of claim 12, wherein the area irradiated by the UV light source is equal to the area of the upper surface of the UV filtering sheet.

15. The method for producing a pre-tilt angle in a liquid crystal panel of claim 12, wherein the UV light source has an output power of 85 nW.

16. The method for producing a pre-tilt angle in a liquid crystal panel of claim 12, wherein the liquid crystal panel is placed on the sample stage in such a way that the thin film transistor substrate of the liquid crystal panel faces upwards.

17. The method for producing a pre-tilt angle in a liquid crystal panel of claim 12, wherein the liquid crystal panel is placed on the sample stage in such a way that the color filter substrate of the liquid crystal panel faces upwards.
